(19) United States
(12) Patent Application Publication
(10) Pub. No.: US 2016/0165504 A1
(43) Pub. Date: Jun. 9, 2016

(54) System, Apparatus And Method For Providing Updating File Through Hereto-Network

(71) Applicants: Inventec (Pudong) Technology Corporation, Shanghai (CN); Inventec Corporation, Taipei City (TW)

(72) Inventor: Xiao Jiang, Shanghai (CN)

(21) Appl. No.: 14/663,164

(22) Filed: Mar. 19, 2015

(30) Foreign Application Priority Data
Dec. 4, 2014 (CN) 201410728248.X

(51) Int. Cl. H04W 36/14; H04W 8/00

(52) U.S. Cl. CPC H04W 36/14; H04W 8/005; H04W 36/22

(57) ABSTRACT

A system, an apparatus and method for updating a file through a hereto-network are disclosed, where a first wireless communications network is relied upon to detect a target device and a second wireless communications network is used for transmitting the updating file, so that the target device connected with the first communications network may receive the updating file through the second wireless communications network and update a target data according to the updating file, whereby the technical efficacy where a bandwidth of other devices may not be influenced when the target device downloads the updating file for updating the target data and multiple target devices may be updated simultaneously may be achieved.

### CROSS-REFERENCE TO RELATED APPLICATION

This application claims the benefit of Chinese Patent Application No. 201410728248.X, filed Dec. 4, 2014.

### BACKGROUND OF THE RELATED ART

1. Technical Field

The present invention relates to a system, an apparatus and a method for updating a target data, and particularly to a system, an apparatus and a method for updating the target data through a hereto-network.

2. Related Art

For the wireless communications devices, using a conventional programmer to update a target data, i.e. a firmware, is not practicable since these devices may be distributed over different positions. A manager may not possibly update these target data by accessing these devices locally one by one. Therefore, the currently available updating manners are transmitting the new target data to these devices, so that these devices may update the target data after receiving a new target data.

In the course of the target data updating, a bandwidth for downloading the new target data is required. However, other devices also require a bandwidth for their normal operations at the same time, resulting in an adverse effect between the device updating the new target data and the other devices working normally.

In view of the above, it may be known that there has long been the issue of the adverse effect between the device updating the new target data and the other devices working normally due to the bandwidth required for downloading the new target data. Therefore, there is quite a need to set forth an improvement means to settle down this problem.

### SUMMARY

In view of the issue existing in the prior art where a bandwidth of other device is influenced when an updating file is downloaded by a target device, the present invention provides a system, an apparatus and a method for updating an updating file through a hereto-network.

According to the present invention, the system for updating a file through a hereto-network comprises at least a target device, storing a target data and connected to a first wireless communications network; a target detection module, detecting the target device through the first wireless communications network; a device management module, transmitting a data updating message to the target device through the first wireless communications, so that the target device is connected to a second wireless communications network; a data transmission module, transmitting an updating file through the second wireless communications network, so that the target device receives the updating file and updates the target data by using the updating file.

According to the present invention, the apparatus for updating a file through a hereto-network comprises a target detection module, detecting at least a target device through a first wireless communications network; a device transmission module, transmitting a updating file to the target device through a second wireless communications network, so that the target device updates the target data by using the updating file received.

According to the method for updating a file through a hereto-network, comprising steps of detecting at least a target device through a first wireless communications network by a target detection module; transmitting a data updating message to the target device through the first wireless communications by a device management module; transmitting an updating file through the second wireless communications network by a data transmission module; and receiving the updating file through the second wireless communications network and updating a target data stored in the target device by using the received updating file by the target device after the target device receives the data updating message through the first wireless communications network.

The system, apparatus and method of the present invention have the difference that the first wireless communications network is relied upon to detect the target device and the second wireless communications network is used for transmitting the updating file, so that the target device connected with the first communications network may receive the updating file through the second wireless communications network and update the target data according to the updating file, whereby the problem encountered in the prior art may be solved and the technical efficacy where multiple target devices are updated simultaneously may be achieved.

### BRIEF DESCRIPTION OF THE DRAWINGS

The present invention will become more fully understood from the detailed description given herein below illustration only, and thus is not limitative of the present invention, and wherein:

FIG. 1 is a system architecture diagram of a system for updating a file through a hereto-network according to the present invention;

FIG. 2A is a schematic diagram illustrating elements of an updating apparatus according to the present invention;

FIG. 2B is an another schematic diagram illustrating elements of updating apparatus according to the present invention;

FIG. 3A is a flowchart of a method for updating a file through a hereto-network according to the present invention;

FIG. 3B is a flowchart of a process of selecting a target device according to the present invention; and

FIG. 3C is a flowchart of a process of updating a target data by the target device according to the present invention.

### DETAILED DESCRIPTION

The present invention will be apparent from the following detailed description, which proceeds with reference to the accompanying drawings, wherein the same references relate to the same elements.

The present invention may transmit an updating file through a wireless communications network used in other than a normal work state of a target device, and transmit a data updating message to the target device through the wireless communications network used for the target device in its normal work state, so that the target device may download the updating file to update a target data by using the wireless communications network used in other than the normal work state by itself. The wireless communications network includes but not only includes ZigBee, Bluetooth, etc.

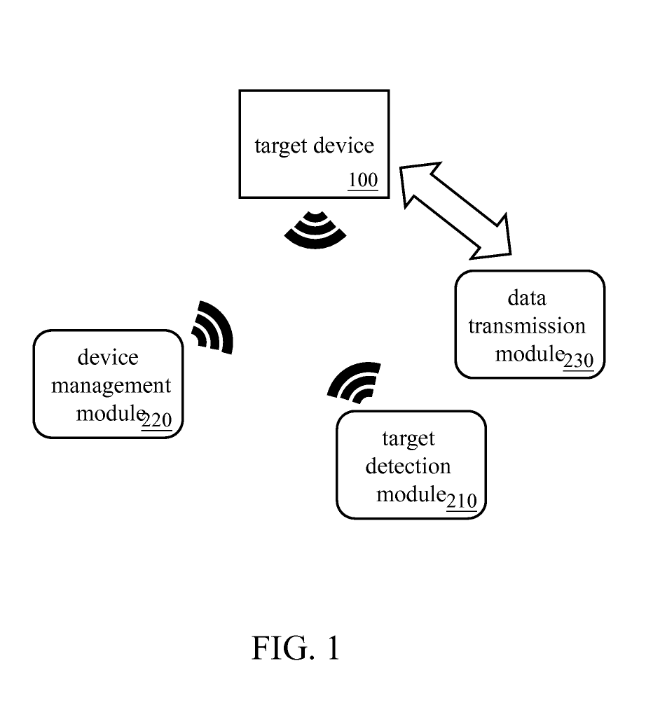

In the following, FIG. 1 is illustrated to explain how the present invention operates , in which FIG. 1 is a system architecture diagram of a system for updating a file through a hereto-network according to the present invention. The system of the present invention comprises a target device 100, a target detection module 210, a device management module 220, and a data transmission module 230.

The target device 100 may be connected by using a first wireless communications network and a second wireless communications network. Generally, the first wireless communications network is a work network of the target device 100, i.e. the target device 100 is generally connected to the first wireless communications network. The second wireless communications network is a network used by the target device 100 for receiving the updating file.

The target device 100 receives a detection message transmitted by the target detection module 210 through the first wireless communications network. And, after the detection message is received, the target device 100 transmits back a response message corresponded by the detection message received through the first wireless communications network to the target detection module 210 or the device management module 220. The response message transmitted by the target device 100 may comprises a data sufficiently recognizing the target device 100, such as the identification data or/and network address of the target device 100. However, these are merely examples without limiting the present invention.

The target device 100 receives a data updating message from the device management module 22 through the first wireless communications network, and gets connected to a second wireless communication network after receiving the data updating message, so that it may receive the updating file transmitted from the data transmission module 230 through the second wireless communications network.

The target device 100 also updates the target data stored by using the updating file received. The target data may a firmware used by the target device 100. However, this is merely an example without limiting the present invention, and any data stored in the target data 100 may be served as the target data of the present invention. Generally, the target data may be stored in a flash, an EEPROM, etc. However, these are merely examples without limiting the present invention.

It is to be particularly noted that the target device 100 may be connected to the first and second wireless communications networks concurrently. In some other embodiments, the target device 100 may be otherwise only connected to the first or second wireless communications networks concurrently. Namely, after the target device 100 receives the data updating message, it requires to get connected from the first wireless communications network to the second wireless communications network. And, after the target data is updated, the target device 100 is switched for its connection from the second wireless communications network to the first wireless communications network.

The target device 100 may also transmit the data updating message to the device management module 220 through the first wireless communications network after updating the target data. If the target device 100 is only connected to the second wireless communications network when updating the data, the target device 100 may transmit the updating finish message only after the connection is switched from the second wireless communications network to the first wireless communications network.

The target detection module 210 is connected to the first wireless communications network and detects the target device 100 through the first wireless communications network. Generally, the target detection module 210 may broadcast the detection message through the first wireless communications network, so that the target device 100 within a signal intensity range with respect to the target detection module 210 may receive the detection message transmitted from the target detection module 210 through the first wireless communications network. The target detection module 210 may also receive the response message transmitted back from the target device 100 through the first wireless communications network, so as to finish the detection on the target device 100. However, how the target detection module 210 detects the target device 100 is not limited to the above described.

In some embodiments, the target detection module 210 may also establish a device list according to the response message received, and may transmit the established device list to the device management module 220. The device list of the present invention may record an identification data and/or network address of the target devices 100 within the signal intensity range of the target detection module 210, i.e. the target device 100 which may receive the detection message. However, the present invention is not only limited to this case.

The target detection module 210 may receive a device search message transmitted from the device management module 220 and broadcast the detection message through the first wireless communications network only after receiving the device detection message, but which does not present as a limiting sense. For example, the target detection module 210 may only broadcast the detection message through the first wireless communications network after an initial operation.

The device management module 220 is connected to the first wireless communications network and transmits the data updating message to the target device 100 through the first wireless communications network.

The device management module 220 may acquire the device list, and may select one, more, or all target devices 100 from the device list to transmit the data updating message, so that the selected target device 100 may be updated. In some embodiments, the device management module 220 may receive the response message transmitted by the target device 100 through the first wireless communications network, and establish the device list according to the received response message. On the other hand, in some other embodiments, the device management module 220 may directly receive the device list established by the target detection module 210 through the first wireless communications network.

In addition, the device management module 220 may also transmit the device detection message to the target detection module 210, or even transmit the data transmission message to the data transmission module 230. When the device management module 220 and the target detection module 210 are physically connected, the physical line may be relied upon to transmit the device detection message. Similarly, when the device management module 220 and the data transmission module 230 are physically connected, the physical line may be relied upon to transmit the data transmission message. On the other hand, if the device management module 220 has no any physical connection to the target detection module 210 and/or the data transmission module 230, the first wireless communications network may be employed to transmit the device detection message and/or the data transmission message.

The data transmission module 230 is connected to the second wireless communications network, and broadcast the updating file through the second wireless communications network, so that the target device 100 may receive the updating file transmitted by the data transmission module 230 through the second wireless communications network.

Generally, the updating file may have a file size larger than what one packet may carry, and thus the data transmission module 230 may divide the updating file into multiple fragments previously so that they may be carried by the packets, and then the packets each containing the fragments may be gradually broadcast onto the second wireless communications network. In some embodiments, the data transmission module 230 may wrap different fragments and the identification data onto different packets and continuously broadcast each of the packets containing different fragments and the identification data corresponding thereto onto the second wireless communications network. For example, the data transmission module 230 may sequentially broadcast the packets including these fragments from the first fragment, and sequentially broadcast the packets including the fragments from the packet including the first fragment again after the packet including the last fragment is broadcast.

Generally, the data transmission module 230 may continuously broadcast the updating file after its initial operation, but which does not present as a limiting sense. For example, the data transmission module 230 may also broadcast the updating file through the second wireless communications network only after receiving the data transmission message transmitted by the device management module 220, and may also stop to broadcast the updating file when a re-broadcast number of times reaches a predetermined number of times or a broadcast time reaches a predetermined time, or after receiving a transmission stop message transmitted by the device management module 220.

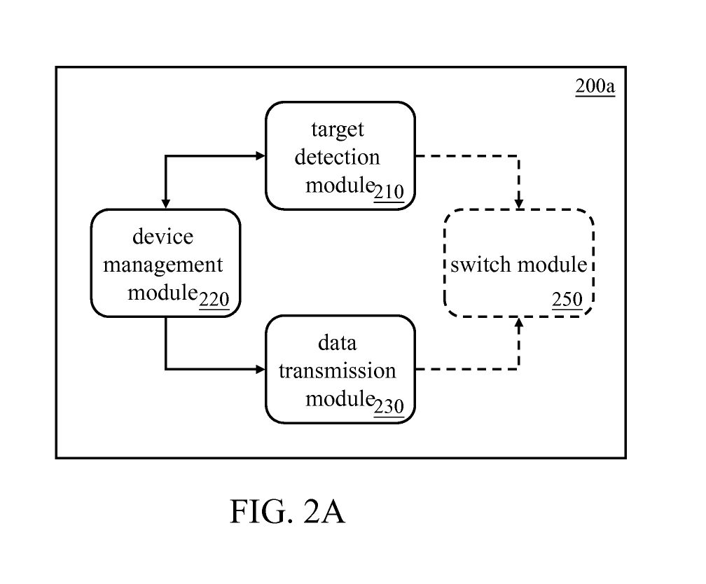

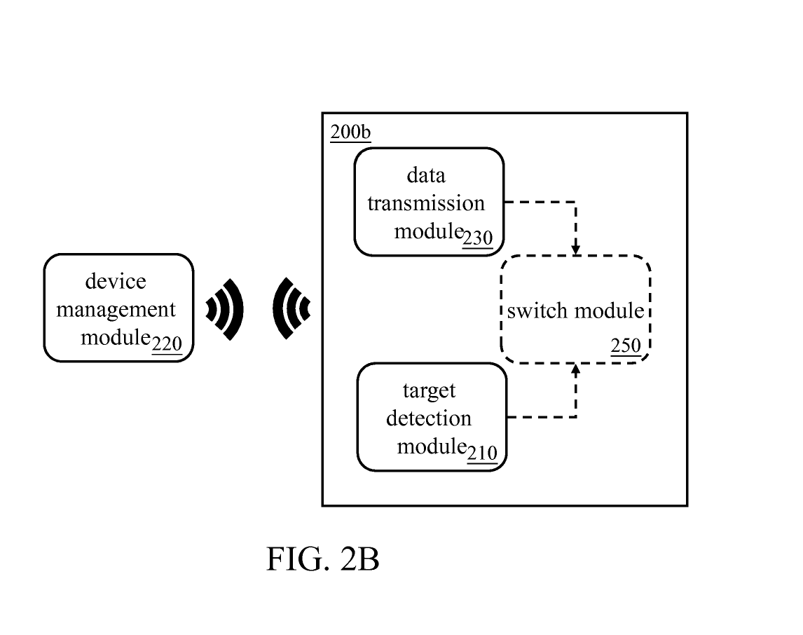

It is to be particularly noted that, in some embodiments, the target detection module 210, the device management module 220, the data transmission module 230 may be contained in an identical updating apparatus 200a, as is shown in FIG. 2A. At this time, the device management module 220 may be connected to the target detection module 210/data transmission module 230 through a physical line. For example, the updating apparatus 200a may be a notebook computer or a laptop computer. The device management module 220 may be contained in an application operated in the updating apparatus 200a. The target detection module 210 and the data transmission module 230 may be may each be a universal serial bus (USB) device, and connected through a USB slot of an updating apparatus 200a to the updating apparatus 200a.

In some embodiments, the device management module 220 may operates at a remote server (not shown in the figure), while the target detection module 210 and the data transmission module 230 may be contained in an updating apparatus 200b, as is shown in FIG. 2B. In this manner, the device management module 220 similarly requires the first wireless communications network to transmit a message to the target detection module 210 and the data transmission module 230.

If the updating apparatus 200a/200b may only connect to the first or second wireless communications network concurrently, the updating apparatus 200a/200b may further contain a switch module 250.

The switch module 250 may enable the updating apparatus 200a/200b to otherwise connect to the second wireless communications network from the original first wireless communications network when the data transmission module 230 receives the data transmission message transmitted by the device management module 220, or the target detection module 210 broadcasts the detection message for a predetermined time. In this manner, the data transmission module 230 may broadcast the updating file through the second wireless communications module , the switch module 250 may also enable the updating apparatus 200a/200b to connect to the first wireless communications network from the second wireless communications network, when the target detection module 210 receives the device search message or when the data transmission module 230 transmits the updating file for a predetermined time, so that the target detection module 210 may broadcast the detection message through the first wireless communications network.

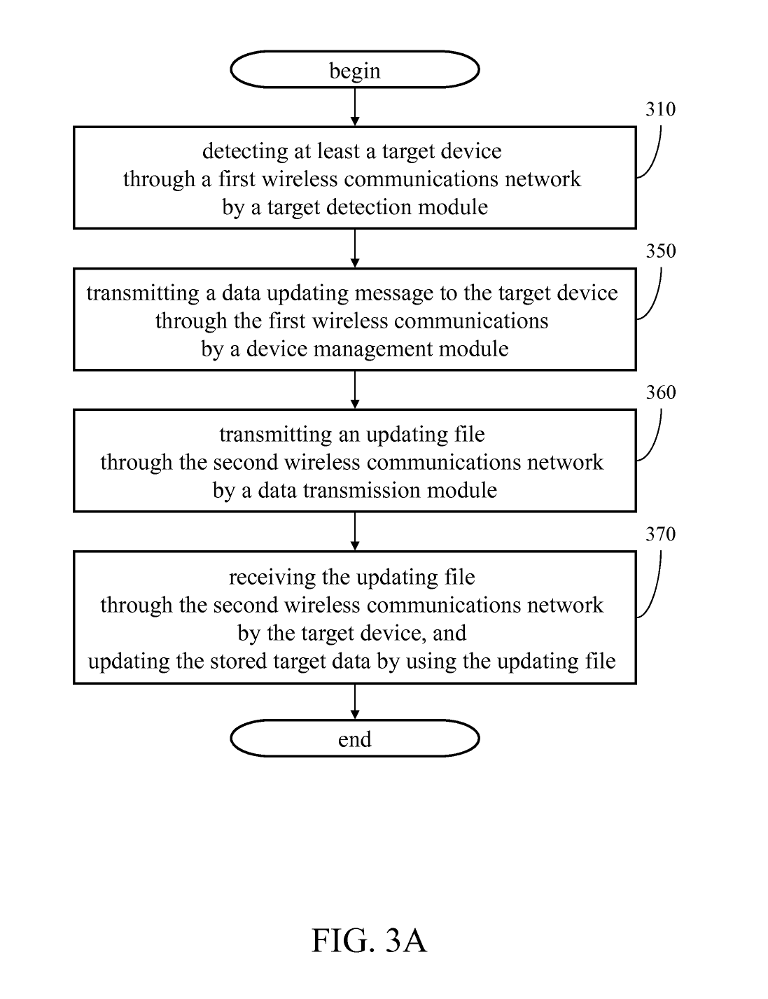

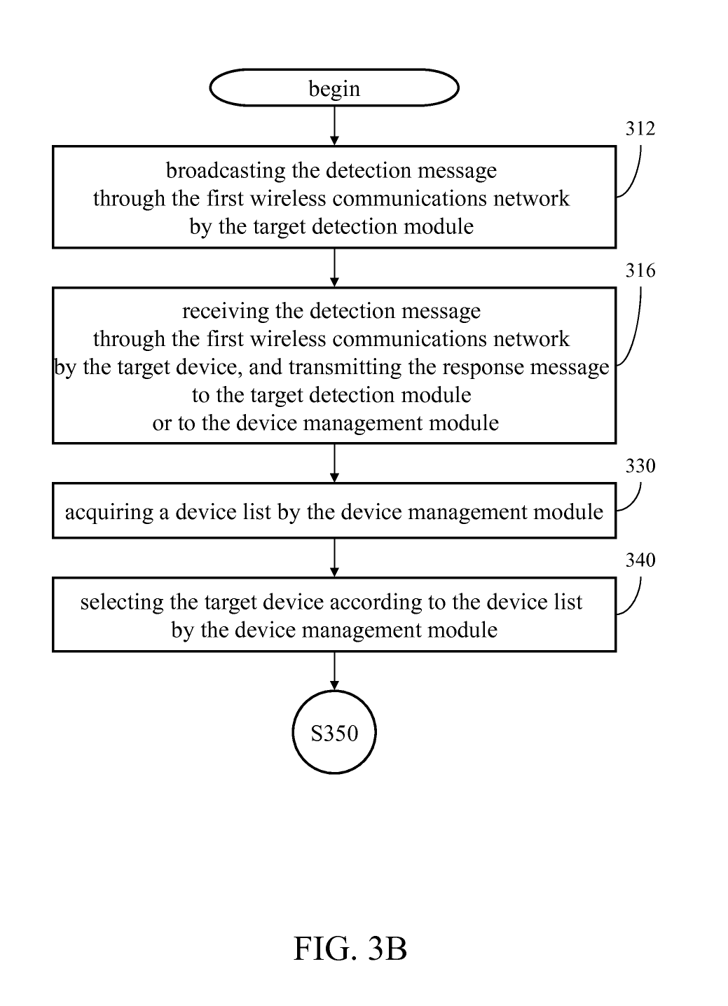

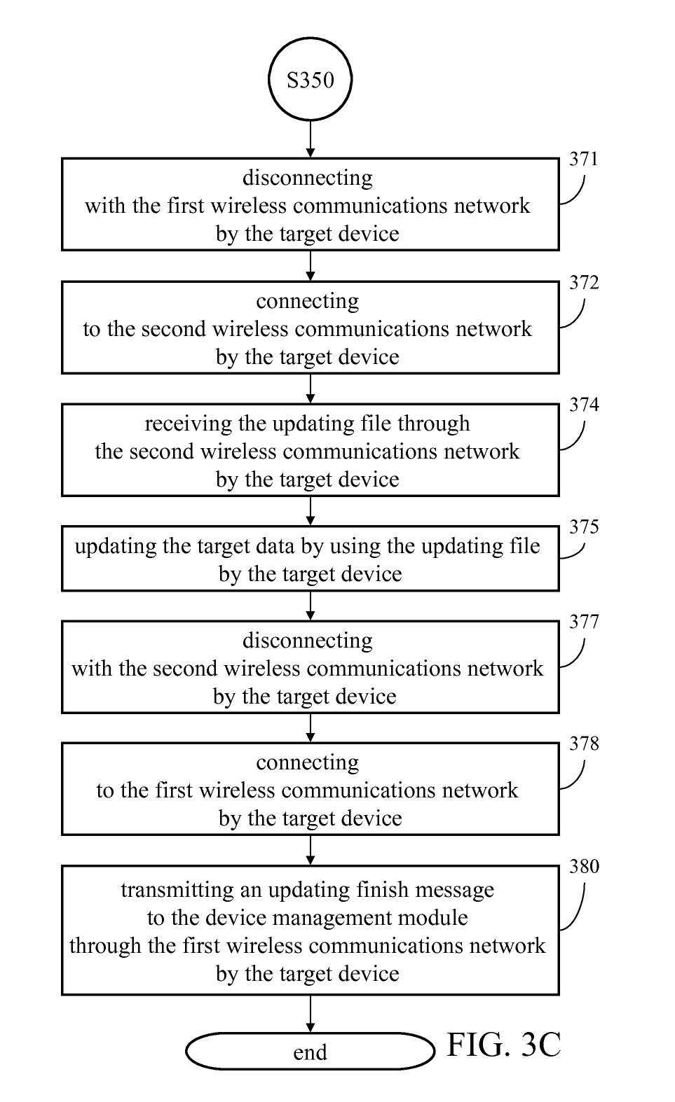

Thereafter, an embodiment will be set forth to explain how the present invention is principally operated, with simulate reference to FIG.3A, which is a flowchart of a method for updating a file through a hereto-network according to the present invention. In this embodiment, assume the first wireless communications network is a ZigBee network while the second wireless communications network is a WiFi network. However, these are merely example without limiting the present invention.

When a manager desires to update a firmware, i.e. target data, of the target device 100, the manager may activate the target detection module 210. After the target detection module 210 operates, the first wireless communications network may be relied upon to detect the target device 100 (S310). In this embodiment, assume the process is presented as shown in FIG. 3B, the target detection module 210 may broadcast the detection message through the first wireless communications network (S312), after the target device 100 within the signal intensity range of the target detection module 210 receives the detection message broadcast by the target detection module 210, it may transmit the response message corresponded by the received detection message through the first wireless communications network to the data transmission module 230 or the device management module 220 (S316).

After the target device 100 transmit the response message through the first wireless communications network, the target detection module 210 finishes its detection on the target device 100, and the device management module 220 may acquire the device list (S330). For example, the target detection module 210 may establish the device list according to the identification data of the target device 100 recorded in the response message received, and may transmit the device list established to the device management module 220. In fact, the device management module 220 may also establish the device list according to the identification data of the target device 100 recorded in the response message received, just as what the target detection module 210 does.

After the device management module 220 obtains the device list (S330), it may transmit the updating message through the first wireless communications network to the target device 100 (S350), i.e. all the target device 100 detected by the target detection module 210 in this embodiment.

In real implementation, the device management module 220 may also select the target devices 100 required to be updated according to the obtained device list (S340), and then transmit the data updating message to the selected target device 100 through the first wireless communications network (S350). In this embodiment, assume the device management module 220 may display the identification data and/or network address of the target devices 100 included in the device list, so that the manager may select the target devices 100 required to be updated according to the identification data and/or network address of the target devices 100 displayed by the device management module 220.

Returning to FIG. 2A, the manager may also activate the data transmission module 230 when the manager desires to launch an updating task. After the data transmission module 230 operates, it may transmit the updating file through the second wireless communications network (S360). In this embodiment, assume the data transmission module 230 may continuously broadcast the updating file onto the second wireless communications network after its initial operation.

In real implementation, the above steps S360 and S310, where the data transmission module 230 transmit the updating file through the second wireless communications network and the above step S350, where the device management module 220 transmit the data updating message to the target device 100 through the first wireless communications have no any particular sequence in presentation. That is, the data transmission module 230 may first transmit the data updating message to the target device 100 (S360) before the target detection module 210 detects the target device 100 through the first wireless communications network (S310) or the device management module 220 transmits the updating message to the target device 100 through the first wireless communications module 220 (S350).

After steps S350 and S360, where the device management module 220transmits the updating message through the first wireless communications network to the target device 110 and the data transmission module 230 transmits the updating file through the second wireless communications network, the target device may receive the data updating message transmitted from the device management module 220 through the first wireless communications network and connect to the second wireless communications network. Thereafter, the target device 100 receives the updating file transmitted by the data transmission module 230 through the second wireless communications network and may update the stored target data by using the updating file received (S370).

As such, the updating file may be transmitted to the target device by the target data used at the time other than a normal work state of the target device by using the present invention, so that a bandwidth used by the target device when its normal work state is presented.

In the above embodiment, as is shown in FIG. 3C in a process form, if the target device 100 fails to connect to the first and second wireless communications networks concurrently, the target device may disconnect its connection with the first wireless communications network (S371) after receiving the data updating message transmitted from the device management module 220 through the first wireless communications network, and connect otherwise to the second wireless communications network (S372).

Thereafter, the target device 100 may receive the updating file transmitted by the data transmission module 230 through the second wireless communications network (S374), and update the target data by using the received updating file (S375).

Then, the target device 100 may disconnect its connection with the second wireless communications network (S377), and connect to the first wireless communications network again (S378), and may transmit the updating finish message to the device management module 220 through the first wireless communications network (S380).

In addition, in the case where the target detection module 210, the device management module 220, and the data transmission module 230 are not distributed over different devices, i.e. the target detection module 210, the device management module 220, and the data transmission module 230 are included in the updating apparatus 200a or only the target detection module 210 and the data transmission module 230 included in the updating apparatus 200b, and the updating apparatus 200a/200b may not connect to the first and second wireless communications network concurrently, in the above embodiment, the switch module 250 in the updating apparatus 200a/200b may enable the target device 100 to be switched to get connected to the second wireless communications network from the original first wireless communications network after the target detection module 210 of the updating apparatus 200a/200b finishes its detection on the target device 100 (S310). In this embodiment, the switch module 250 may enable the target device 100 to be switched to get connected to the second wireless communications network from the original first wireless communications network after a predetermined time after the target detection module 210 broadcasts the detection message or the data transmission module 230 receives the data transmission message transmitted by the device management module 220, so that the data transmission module 230 may broadcast the updating file through the second wireless communications network.

On the other hand, after the data transmission module 230 in the updating apparatus 200a/200b transmits the updating file through the second wireless communications network (S360), the switch module 250 in the updating apparatus 200a/200b may also switch the connection of the target device 100 from the second wireless communications network to the first wireless communications network. In this embodiment, assume the switch module 250 may switch the connection of the updating apparatus 200a/200b from the second wireless communications network to the first wireless communications network after a predetermined time after the data transmission module 230 transmits the updating file or the target detection module 210 receives the device search message transmitted by the device management module 220, so that the target detection module 210 broadcast the detection message through the first wireless communications network.

In summary, it may be known that the system and method of the present invention have the difference as compared to the prior art that the first wireless communications network is relied upon to detect the target device and the second wireless communications network is used for transmitting the updating file, so that the target device connected with the first communications network may receive the updating file through the second wireless communications network and update the target data according to the updating file, whereby the problem encountered in the prior art where a bandwidth of other device is influenced when the target device downloads the updating file for updating the target data may be solved and the technical efficacy where multiple target devices are updated simultaneously may be achieved.

Furthermore, the method for updating a firmware through the hereto-network according to the present invention may be implemented in a hardware, a software or a combination thereof, and may also be implemented in a computer system in a concentrated fashion or discretely in interconnected elements in a computer system in a distributed fashion.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for updating a file through a hereto-network, comprising:
at least a target device, storing a target data and connected to a first wireless communications network;
a target detection module, detecting the target device through the first wireless communications network;
a device management module, transmitting a data updating message to the target device through the first wireless communications, so that the target device is connected to a second wireless communications network;
a data transmission module, transmitting the updating file through the second wireless communications network, so that the target device receives an updating file and updates the target data by using the updating file.

2. The system for updating the file through the hereto-network as claimed in claim 1, wherein the target detection module broadcast a detection message through the first wireless communications network, and the target device receives the detection message through the first wireless communications network and transmits a response message to the target detection module or the device management module.

3. The system for updating the file through the hereto-network as claimed in claim 1, wherein the target device further disconnects with the first wireless communications network before connecting to the second wireless communications network.

4. The system for updating the file through the hereto-network as claimed in claim 1, wherein the target device further connects to the first wireless communications network again after updating the target data by using the updating file.

5. The system for updating the file through the hereto-network as claimed in claim 1, wherein the target device further transmits an updating finish message to the device management module through the first wireless communications network.

6. The system for updating the file through the hereto-network as claimed in claim 1, wherein the device management module further acquires a device list and selects the target device to transmit the data updating message from the device list.

7. The system for updating the file through the hereto-network as claimed in claim 1, wherein the device management module transmits a device search message to the target detection module, and the target detection module further detects the target device after receiving the device search message.

8. An apparatus for updating a file through a hereto-network, comprising:
a target detection module, detecting at least a target device through a first wireless communications network;
a device transmission module, transmitting an updating file to the target device through a second wireless communications network, so that the target device updates the target data by using the updating file received.

9. The apparatus for updating the file through the hereto-network as claimed in claim 8, further comprising a device management module for transmitting a data updating message to the target device, so that the target device connects with the second wireless communications network.

10. The apparatus for updating the file through the hereto-network as claimed in claim 9, wherein the device management module further acquires a device list and selects the target device to transmit the data updating message from the device list.

11. The apparatus for updating the file through the hereto-network as claimed in claim 9, wherein the device management module transmits a device search message to the target detection module, and the target detection module further detects the target device after receiving the device search message.

12. The apparatus for updating the file through the hereto-network as claimed in claim 8, further comprising a switch module for switching a connection of the apparatus from the first wireless communications network to the second wireless communications network when the data transmission module receives a data transmission message through the first wireless communications network, and for switching a connection of the apparatus from the second wireless communications network to the first wireless communications network when the target detection module receives a device search message.

13. The apparatus for updating the file through the hereto-network as claimed in claim 8, wherein target detection module broadcasts a detection message through the first wireless communications network to the target device for detecting the target device.

14. A method for updating a file through a hereto-network, comprising steps of:
detecting at least a target device through a first wireless communications network by a target detection module;
transmitting a data updating message to the target device through the first wireless communications by a device management module;
transmitting an updating file through the second wireless communications network by a data transmission module, and
receiving the updating file through the second wireless communications network and updating a target data stored in the target device by using the received updating file by the target device after the target device receives the data updating message through the first wireless communications network.

15. The method for updating the file through the hereto-network as claimed in claim 14, further comprising a step of acquiring a device list and selecting the target device from the device list by the device management module before the step of transmitting the data updating message to the target device through the first wireless communications by the device management module.

16. The method for updating the file through the hereto-network as claimed in claim 14, further comprising a step of transmitting a device search message to the target device module by the device management module before the step of detecting the target device through the first wireless communications network by the target detection module.

17. The method for updating the file through the hereto-network as claimed in claim 14, wherein the step of detecting at least a target device through a first wireless communications network by a target detection module further comprising steps of broadcasting a detection message through the first wireless communications network by the target detection module, receiving the detection message through the first wireless communications network and transmitting a response message to the target detection module or the device management module by the target device.

18. The method for updating the file through the hereto-network as claimed in claim 14, further comprising a step of disconnecting with the first wireless communications network and then connecting to the second wireless communications network by the target device before the step of receiving the updating file through the second wireless communications network by the target device.

19. The method for updating the file through the hereto-network as claimed in claim 14, further comprising a step of connecting to the first wireless communications network again by the target device after the step of updating the target data by using the updating file.

20. The method for updating the file through the hereto-network as claimed in claim 14, further comprising a step of transmitting an updating finish message to the device management module through the first wireless communications network by the target device after the step of updating the target data by using the updating file.
